(19) United States
(12) Patent Application Publication
(10) Pub. No.: US 2006/0185143 A1
(43) Pub. Date: Aug. 24, 2006

(54) Method and device for manufacturing sections for transportation systems

(75) Inventors: Holger Frauen, Hamburg (DE); Tomas Gnauck, Neu Wulmstorf (DE); Eike Klemkow, Schwerin (DE)

Correspondence Address: CHRISTOPHER PARADIES, PH.D., FOWLER WHITE BOGGS BANKER, P.A., 501 E KENNEDY BLVD, STE. 1900, TAMPA, FL, 33602, US

(73) Assignee: Airbus Deutschland GmbH, Hamburg (DE)

(21) Appl. No.: 11/286,771

(22) Filed: Nov. 22, 2005

(30) Foreign Application Priority Data
Nov. 22, 2004 (DE) 10 2004 056 285.7
Nov. 22, 2004 (DE) 10 2004 056 286.5
Nov. 22, 2004 (DE) 10 2004 056 287.3
Nov. 22, 2004 (DE) 10 2004 056 284.9

(51) Int. Cl. B23P 21/00

(52) U.S. Cl. 29/33 K

(57) ABSTRACT

A device for manufacturing sections that are composed of several individual components uses a plurality of workstations. According to an embodiment of the invention, each workstation is designed for carrying out at least one of at least three manufacturing steps. Sections may be processed in each workstation regardless of their shape and/or size. A specialized manufacturing step such as assembly and tacking, connecting, finishing or performing follow-up work is carried out in each workstation. This allows a high degree of automation in at least some of the stations and improved capacity utilization, because the sections are transferred to a downstream workstation after the completion of the respective manufacturing. In one example, a method for manufacturing sections for transportation devices, such as aircraft, by assembling several individual components in a plurality of workstations is disclosed. One of at least three manufacturing steps is carried out in each workstation and the respective sections are processed in each workstation regardless of their shape and/or size.

### RELATED APPLICATIONS

This application claims the benefit of the filing date of German Patent Application Nos. 10 2004 056 287.3 filed Nov. 22, 2004, 10/2004 056284.9; 10/2004 056286.5; 10/2004056285.7, each, the disclosures of which are hereby incorporated herein by reference.

### FIELD OF THE INVENTION

The field relates to a device for manufacturing sections for transportation device, such as an aircraft, which is composed of several individual components with a series of workstations.

### TECHNOLOGICAL BACKGROUND

Various devices and methods for manufacturing sections for aircraft are known and are associated with the increasing popularity of sectional construction techniques.

In known devices and methods, a section remains in one and the same workstation until it is nearly completed. This principle is only economically feasible if the sections are predominantly assembled manually. In highly automated manufacturing processes, riveting robots are commonly used for connecting individual components, particularly fuselage shells and floor frames, into complete sections. In such instances, it is not efficient for the completely assembled section to remain in the same workstation for follow-up work because the very costly equipment may not be used for extended periods of time while this possibly time-consuming follow-up work is performed.

Until now, only sections with specifically defined lengths and/or cross-sectional geometries could be processed in conventional workstations of this type. For example, known devices and methods currently do not make it possible to manufacture sections for different versions of the same type of aircraft or sections for completely different types of aircraft in one and the same workstation and with the same tools. Up to now, the assembly of sections for different types of aircraft and/or different versions of the same type of aircraft, for example, in the form of short-range and long-range versions, requires specially designed workstations as well as individually adapted tools. Each workstation needs to be individually adapted to the section to be manufactured. In other words, sections for different types of aircraft and/or for different versions of the same type of aircraft may not be manufactured in the same workstation with known devices and methods.

Therefore, known methods and devices are only conditionally suitable for the efficient assembly of aircraft fuselage sections by means of modern, highly automated manufacturing methods.

### SUMMARY OF THE INVENTION

A device for manufacturing sections for transportation device such as an aircraft, which has sections that are composed of several individual components, comprises a plurality of workstations, wherein each workstation may perform one of at least three manufacturing steps. In each workstation, sections may be processed regardless of their shape and/or size.

According to one embodiment, a device and a method may provide an advantage of efficient capacity utilization of the production workstations, even if the sections for aircraft fuselage cells are manufactured in a highly automated fashion. In addition, a device and a method may provide another advantage, allowing manufacturing of sections of different sizes, particularly different lengths and/or different cross-sectional dimensions and/or cross-sectional geometries, in one and the same production workstation even in cases of a high level of automation. A superior capacity utilization of each individual workstation may also be achieved in highly automated manufacturing methods, because each workstation is designed for carrying out one of at least three manufacturing steps, and the respective sections may be processed in each workstation regardless of their shape and/or size. Since manufacture of practically any size may be carried out, sections may be assembled for different types of aircraft and for different versions of the same type of aircraft, such as short-range and long-range versions, in the same workstation or in the same arrangement of workstations reducing the costs of redundant production means that are currently required for each type of aircraft.

In another embodiment of the device, the workstations are at least partially provided with handling or manipulator devices, such as robots, automatic positioning devices and/or manual processing devices, capable of improving productivity of the entire manufacturing device. At least one buffer facility is provided in another embodiment of the device. The buffer facility may allow for compensation of work flow fluctuations in the respective workstations,

An improved or optimal capacity utilization of the individual workstations may be achieved in that one of at least three manufacturing steps may be carried out in each workstation and sections of any shape and/or size may be processed in each workstation. This may be important if the manufacturing methods are highly automated. The ability to manufacture sections of any shape and/or size also allow for sections for different types of aircraft and for different versions of the same type of aircraft, for example, long-range and short-range versions, to be assembled such that fewer resources may be required.

In another embodiment of the method, the individual components are assembled into transportable sections and tacked together in at least one workstation that includes an assembly and tacking apparatus in a first manufacturing step, wherein the individual components of the formed sections are connected to one another in at least one workstation that includes a connecting apparatus in a second manufacturing step, and wherein the sections are finished and/or follow-up work is performed on the sections in a least one workstation that includes a finishing apparatus in a third manufacturing step.

Only one specific step is respectively carried out in each workstation such that a superior capacity utilization of the respective workstations may be achieved. This is particularly important if the respective workstations operate in a highly automated fashion. After the respective manufacturing step is completed, the section is transferred from the workstation in question to the next workstation.

In another embodiment of the method, the residence times of the sections in the workstations are varied depending on the amount of work to be performed, such as dependence on the lengths and/or the cross-sectional dimensions of the respective sections. Thus, each section only remains in a workstation until the manufacturing steps to be carried out are completed. Sections of larger dimensions typically remain in a workstation longer than sections of smaller dimensions. Consequently, the sections are not transferred between the respective workstations in fixed cycles.

In another embodiment of the method, the sections may be transferred between the workstations via at least one buffer facility. This embodiment may compensate for fluctuations in the work flow in the individual workstations, such that neither workstation has to wait for the completion of a section in the preceding workstation. According to another embodiment of this method, the sections bypass at least one buffer facility during their transfer between workstations. This may prevent unnecessary time delays if an intermediate storage is not required. In another embodiment of the method, the sections are transferred between the workstations and/or between the workstations and at least one buffer facility by means of at least one transport device, such as an automatically and/or manually controlled transport vehicle. This embodiment may allow for the method to be performed in a fully automated fashion without human intervention and/or in an at least partially manual fashion.

### BRIEF DESCRIPTION OF THE DRAWINGS

FIG. 1 illustrates a schematic diagram of one embodiment of the device.

### DETAILED DESCRIPTION OF THE PREFERRED EMBODIMENTS

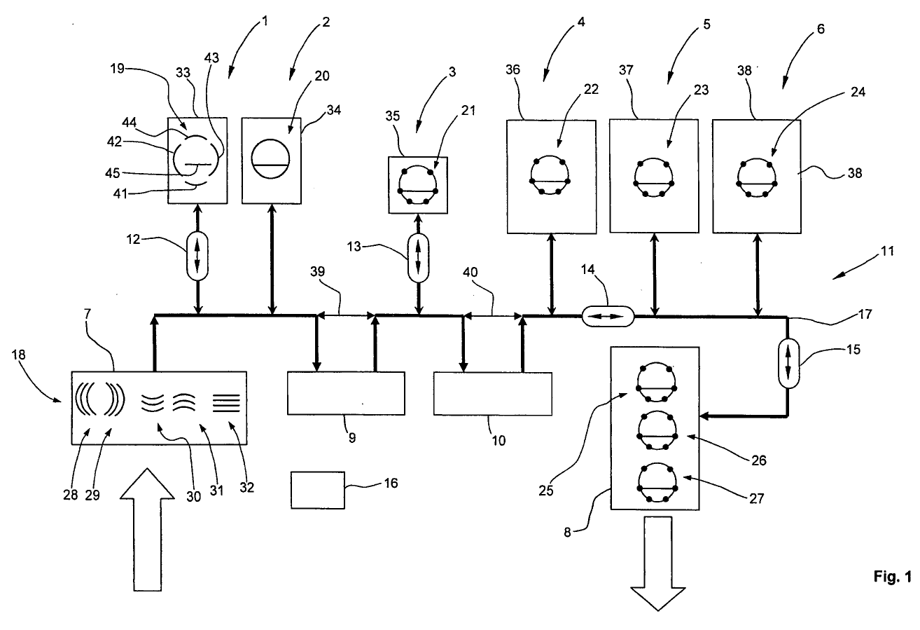

A system comprises, among other things, the workstations 1, 2, 3, 4, 5 and 6 as illustrated in FIG. 1. The system may have an arrival repository 7, a departure repository 8 and two buffer facilities 9 and 10. The workstations 1 to 6 as well as the arrival repository 7, the departure repository 8 and the buffer facilities 9, 10 are coupled in a network to one another by a transport device 11. The transport device 11 may comprises four transport vehicles 12, 13, 14, 15 that serve to transport sections of an aircraft supported in one of the transports. Additional transport vehicles may be provided but are not illustrated in FIG. 1. For example, these additional transport vehicles and the sections lying thereon are situated in the workstations 1 to 6, the buffer facilities 9, 10 or the departure repository 8. A control and/or regulating unit 16 may control all above-described components. In one example, the control and/or regulating unit 16 may be a complex electronic computing device, such as a mainframe computer or a network of computer systems.

The transport vehicles 12, 13, 14, 15 move along according to a guidance system 17. For example, a rail system may be used. The guidance device 17 may also include contactless guide elements, such as induction loops or laser-based control means. The transport vehicles 12, 13, 14, 15 may be moved along guidance system 17 in the direction indicated by the black double arrows. Alternatively, the movement of the transport vehicles 12, 13, 14, 15 may be controlled without a mechanical guidance device 17, such as a GPS system, a local positioning system or the like. The movement of the transport vehicles 12, 13, 14, 15, may be accomplished with wheels, rolls, rollers, chains, rail wheels or the like, wherein the transport vehicles may be in the form of underfloor vehicles. Alternatively, the transport vehicles 12, 13, 14, 15 may be moved on the ground in a contactless fashion, for example, such as on cushions of air, magnetic fields or the like. The guidance device 17 may contains a plurality of junctions which are not illustrated in detail in FIG. 1 that serve to redirect the transport vehicles 12, 13, 14, 15 between the workstations 1 to 6, the buffer facilities 9, 10, the arrival repository 7 and the departure repository 8 under the control of the control and/or regulating unit.

A variety of individual components 18 required for the assembly of the sections 19 to 27 are intermediately stored in the arrival repository 7. The individual components 18, for example, are left lateral shells 28, right lateral shells 29, bottom shells 30, top shells 31, as well as floor frames 32. The assembly of the sections 19 to 27 from left lateral shells 28, right lateral shells 29, bottom shells 30, top shells 31 and floor frames 32 is also referred to as a “four shell design”. Alternatively, the device and the method may also be utilized for assembling sections from so-called upper and lower half shells. In this case, the upper and lower half shells are already provided with the floor frame. This design with lower and upper half shells is also referred to as a “half shell design”. A corresponding number of upper and lower half shells may be stored in the arrival repository 7 in this case. The sections 19 to 27 may be assembled in accordance with the four shell design as well as the half shell design in each of the workstations 1 to 6 of the device according to the invention.

Two workstations 1, 2 contain an assembly and tacking apparatus 33, 34, respectively, as shown in FIG. 1. The individual components 18 are positioned in the assembly and tacking apparatuses 33, 34 such that the sections 19, 20 are formed. For example, the individual components 18 of a symbolically illustrated section 19 are currently positioned in the first workstation 1. The symbolically illustrated section 20 in the second workstation 2 is already assembled or assembled and tacked, respectively. The individual components 18 may be positioned relative to one another in the assembly and tacking apparatuses 33, 34 using automatic positioning devices. Then the components 18 are minimally tacked together such that the partially tacked section may be transported without distortion. The positioning devices are controlled by the control and/or regulating unit 16, in this example.

The assembly and tacking apparatuses 33, 34 respectively comprise at least one tacking apparatus manually and/or automatically tacking together the individual components 18. The tacking of the individual components 18 may be accomplished by means of riveting, bonding, welding, such as friction twist welding, clamping, pressing or the like. The sections 19, 20 are moved out of the assembly and tacking apparatuses 33, 34 after the tacking process is completed. The sections 19, 20 remain on the respectively assigned transport vehicle such as one of the transport vehicles 12-15, during the entire manufacturing process, for example.

Th third workstation 3 contains at least one connecting apparatus 35. A section 21 on which the connections are finished is shown in the connecting apparatus 35. The individual connecting points of the section 21 are symbolized by small circular thickenings on the periphery that are not identified in more detail in order to provide better clarity. The individual components 18 of the section 21 are definitively and rigidly connected to one another in the connecting apparatus 35 with the aid of a connecting mechanism, such as automatic handling or manipulator systems, including robots with articulated arms or conventional track-guided and at least partially automated manipulator devices. The connections between the individual components 18 may be produced, using riveting, bonding, welding, such as friction twist welding or the like. Preferably, a section remains in the connecting apparatus 35 for the shortest time possible in order to achieve superior capacity utilization, because the connecting apparatus 35 often requires a substantial period for completion.

The fourth, fifth and sixth workstations 4, 5, 6 comprise finishing apparatus 36, 37, 38 for completing finishing steps. The sections 22, 23, 24 may conform to specific customer requirements in the finishing apparatuses 36, 37, 38. For example, customer-specific adaptations may include the installation of mounting elements for seats, on-board kitchens, sanitary installations and the like. The finishing apparatuses 36, 37, 38 also serve to perform follow-up work. This follow-up work may be processes that could not be finished or not completely finished in the preceding workstations 1, 2, 3. Thus, residence times in these earlier workstations by be reduced in order to increase capacity utilization.

The transport between the assembly and tacking apparatuses 33, 34, the connecting apparatus 35, the buffer facilities 9, 10 and the finishing apparatuses 36, 37, 38 accomplished with the aid of the transport vehicles 12 to 15 directed by the guidance device 17 under the control of the control and/or regulating unit 16. The number of transport vehicles 12 to 15 used may be correlated to the number of sections being processed in any example of the system. Additional transport vehicles may be required when sections need to be placed on stand-by in the buffer facilities 9, 10 and in the departure repository 8.

The costs for realizing the system may be reduced if the transport vehicles 12 to 15 are two-part vehicles, for example. A transport vehicle 12 to 15 may include, an undercarriage that serves to move the transport vehicle along the guidance device 17. A positioning frame arranged on the undercarriage may be removed from the undercarriage and parked. This positioning frame accommodates a section during its transport and may be used for parking and/or positioning a section within a workstation 1 to 6, saving on the number of undercarriages required to move sections through the system.

During the operation of one example of the system, a transport vehicle composed of an undercarriage and a positioning frame transports a section lying on the positioning frame into one of the workstations 1 to 6 and parks the positioning frame together with the section. Before the processing of the section begins, the positioning frame, in one example, may need to be precisely aligned relative to the workstation 1 to 6 by means of positioning elements which are arranged on the positioning frame.

After the positioning frame is parked, the undercarriage may immediately depart the workstation and receive another positioning frame with a new section to be transported into or out of another workstation 1 to 6. The separation of the transport function of the transport vehicles 12 to 15 from the parking and positioning function of the positioning frame provides an advantage of only requiring a positioning frame for each section rather than a complete transport vehicle. Consequently, the device may be operated with a significantly smaller number of undercarriages. In one example, a single undercarriage is capable of moving each of the sections.

Two buffer facilities 9, 10 allow for the brief intermediate storage of sections in case a workstation 1 to 6 is not yet ready to receive a section that has undergone a proceeding manufacturing step. Such instances, may occur if the connecting apparatus 35 requires more time than expected for producing the final connections between the components of a section, for example. The transport vehicles may pass by buffer facilities 9, 10 on bridgings 39, 40 if intermediate storage is not needed.

In addition, the system includes a departure repository 8 for receiving several sections 25, 26, 27. The departure repository 8 allows for placement of a certain number of sections on stand-by for subsequent manufacturing steps. Thus, downstream or subsequent manufacturing stations may continue to operate in case the manufacturing process in the device comes to a standstill due to a fault in the system or supply chain.

According to one embodiment of the invention, the individual components of the sections 19 to 27 are only correctly positioned and tacked together in the assembly and tacking apparatuses 33, 34, and the connecting apparatus 35 only produces the final connection between the individual components of the sections 19 to 27. A very high productivity of the entire system is achieved due to the high level of specialization in the individual workstations 1 to 6, particularly in connection with the high level of automation in the first three workstations 1 to 3.

The sections 19 to 27 may conform to specific customer requirements in the three finishing apparatuses 36, 37, 38, wherein most of these adaptations are still performed manually and are therefore quite time-consuming. Possibly required follow-up work may also be performed in the finishing apparatuses 36, 37, 38. The assembly and tacking apparatuses 33, 34 as well as the connecting apparatus 35 may be accomplished with a comparatively high level of automation such that the residence times of the sections in these first three workstations 1 to 3 may be shortened in order to ensure a sufficient capacity utilization. This is also reflected in the quantitative ratio between the two assembly and tacking apparatuses 33, 34, the connecting apparatus 35 and the three finishing apparatuses 36, 37, 38. The specialization of the manufacturing steps carried out in the workstations 1 to 6 forms the foundation for the use of highly automated manufacturing processes in the construction of aircraft sections. However, any quantitative ratio may be selected for the number of assembly and tacking stations, the number of connecting stations and the number of finishing stations, in order to better optimize capacity utilization.

According to one embodiment of the invention, the assembly and tacking apparatuses 33, 34, the connecting apparatus 35 and the finishing apparatuses 36, 37, 38 may be accomplished in such a way that sections of different shapes and/or sizes may be processed. For example, sections for different types of aircraft and for different versions of the same type of aircraft, which may have a significantly varying cross-sectional dimensions and/or cross-sectional geometries, may be very flexibly manufactured in the workstations 1 to 6. In one example, sections with significantly varying cross-sectional geometries may have cross-sectional dimensions between approximately 2 and 14 metres. The high manufacturing flexibility is primarily achieved due to the utilization of automated manipulator devices, such as industrial robots, robots with articulated arms or at least partially automated track-guided manipulator devices. These manipulator devices in connection with the specialization of the workstations allow a significant variability with respect to sections of different sizes and/or and geometric shapes.

The control and/or regulating unit 16 serves to control and monitor all processes being carried out in the device. For this purpose, the control and/or regulating unit, in one example, is coupled to the arrival repository 7, the departure repository 8, the buffer facilities 9, 10, the workstations 1 to 6 as well as the transport device 11 and its transport vehicles 12 to 15 via control lines and measuring lines which are not illustrated in greater detail in FIG. 1.

In one example of the method, the individual components 18 required for manufacturing a section are initially removed from the arrival repository 7 and then transported to one of the two assembly and tacking apparatuses 33, 34. The arrival and departure repositories 7, 8 may be bypassed and the individual components 18 may be directly delivered to the respective workstation.

The method, in one example, is described below with reference to the section 19. For example, a bottom shelf 41 for the assembly of the section 19 may be initially loaded on one of transport vehicles 12 to 15, positioned, and placed into the assembly and tacking apparatus 33. In FIG. 1, the transport vehicle 12 is no longer illustrated in the region of the workstation 1 in order to provide a better overview. If the transport vehicle 12 is formed of two parts, the positioning frame is separated from the undercarriage and then is precisely positioned and/or aligned in the assembly and tacking apparatus 33. All of the individual components 18 to be assembled are aligned relative to the bottom shell 41. The positioning frame with the bottom shell 41 lying thereon remains in the assembly and tacking apparatus 33 until this particular manufacturing step is completed. However, the undercarriage may depart the station in order to transport other individual components 18 or another section 19-27. For the remainder of the manufacturing process, the section 19 remains on the assigned transport vehicle and/or, when using two-part transport vehicles, on the assigned positioning frame.

Subsequently, a left lateral shell 42, a right lateral shell 43, a top shell 44 and a floor frame 45 are removed from the arrival repository 7 and are transported to the assembly and tacking apparatus 33. In the assembly and tacking apparatus 33, these individual components are then exactly aligned and positioned relative to one another. The respective positions of the individual components are determined, for example, with the aid of a shown measuring device that is connected to the control and/or regulating unit 16. Based on the position values acquired by the measuring device, the control and/or regulating unit 16 is able to correspondingly position positioning elements for aligning the individual components relative to one another in accordance with a pre-stored simulation model. Although the entire process takes place in a fully automated fashion, the process may be manually intervened, if so required. The bottom shell 41, the left lateral shell 42, the right lateral shell 43, the top shell 44 and the floor frame 45 are then tacked together in a fully automated fashion. Automated manipulator devices, such as robots with articulated arms or at least partially automated track-guided manipulator devices equipped with corresponding tools, may be used. The individual components may be tacked together with suitable tools, for example, by means of riveting, bonding, welding, such as friction twist welding, clamping, pressing or the like. However, according to an embodiment of the invention, a section 19 is only tacked together to such a degree that it may be transported by means of the transport vehicle 12 and a deformation of the section due to its own weight is prevented. This low level of tacking ensures that the section 19 is able to depart the assembly and tacking apparatus 33 after a short period of time.

The section 19 situated on the assigned transport vehicle 12 is then transported into the connecting apparatus 35. In one example, the individual components are definitively and rigidly connected in the connecting apparatus 35. For this purpose, the connecting apparatus 35 is provided with automated manipulator devices, such as standard industrial robots, robots with articulated arms or automated track-guided manipulator devices equipped with corresponding tools. The final connections between the individual components of the section 19 are produced, for example, by means of riveting, bonding, welding, such as friction twist welding, pressing or the like. The connections between the individual components forming may be produced in a fully automated fashion under the control of the control and/or regulating unit 16. Due to the high level of automation of the connecting apparatus 35, the residence times of the sections in this station is greatly reduced in order to ensure a proper capacity utilization of the connecting apparatus 35.

The definitively and rigidly connected section 19 is now transported out of the connecting apparatus 35 by means of the transport vehicle 12 and transferred into one of the three finishing apparatuses 36 to 38. For example, the section 19 is adapted, among other things, to specific customer requirements and/or follow-up work is performed in the finishing apparatus 36. Due to the broad variety of manufacturing steps to be performed in this station, the level of automation is comparatively low, with much of the work performed manually. This means that the residence time of a section may be longer in the finishing apparatuses 36-38 than in other stations. Consequently, three finishing apparatuses 36, 37, 38 are provided in the example for accommodating the sections that have already undergone the manufacturing steps in the assembly and tacking apparatuses 33, 34 and the connecting apparatus 35. The sections may also be intermediately stored in the buffer facilities 9, 10, such that the sections are not directly transported to the respectively following workstation 1 to 6 in this case. Such instances occur, for example, when one of the workstations 1 to 6 is not yet ready to receive a section and no second equivalent workstation 1 to 6 is available. After the processing in one of the three finishing apparatuses 36 to 38, the finished section 19 is transported into the departure repository 8 by means of the transport vehicle 12, and then to other manufacturing sites or stations, when required.

The manufacturing sequence described above with reference to the section 19 is one of many examples. The transport device 11 in connection with the transport vehicles 12 to 15 shown, the buffer facilities 9, 10, the arrival repository 7 and the departure repository 8 allow for a variety of different manufacturing sequences that respectively have specific advantages and disadvantages. In addition, the number of workstations 1 to 6 or the number of assembly and tacking apparatuses 33, 34, the number of connecting apparatuses 35 and the number of finishing apparatuses 36 to 38 may be varied in accordance with manufacturing requirements. As mentioned above, the method and the device allow for manufacturing of sections in accordance with the aforementioned “half shell design” or the aforementioned “four shell design,” regardless of their shapes and sizes.

It should be noted that the term “comprising” does not exclude other elements or steps and the “a” or “an” does not exclude a plurality. Also elements described in association with different embodiments may be combined.

Implementation of the invention is not limited to the preferred embodiments shown in the figures. Instead, multiple variations are possible and will be readily apparent based on the examples described herein.

### List of Reference Numerals

1 Workstation
2 Workstation
3 Workstation
4 Workstation
5 Workstation
6 Workstation
7 Arrival repository
8 Departure repository
9 Buffer facility
10 Buffer facility
11 Transport device
12 Transport vehicle
13 Transport vehicle
14 Transport vehicle
15 Transport vehicle
16 Control and/or regulating unit
17 Guidance device
18 Individual components
19 Section
20 Section
21 Section
22 Section
23 Section
24 Section
25 Section
26 Section
27 Section
28 Left lateral shell
29 Right lateral shell
30 Bottom shell
31 Top shell
32 Floor frame
33 Joining and tacking apparatus
34 Joining and tacking apparatus
35 Connecting apparatus
36 Finishing apparatus
37 Finishing apparatus
38 Finishing apparatus
39 Bridging
40 Bridging
41 Bottom shell
42 Left lateral shell
43 Right lateral shell
44 Top shell
45 Floor frame

1. A system for manufacturing sections composed of several individual components, the device comprising:
a plurality of workstations,
each workstation is capable of carrying out at lease one of at least three manufacturing steps, and each workstation is capable of processing sections having different shapes, different sizes, or both thereof.

2. The system of claim 1, wherein the workstations are capable of processing sections having different lengths, different cross-sectional dimensions or both thereof.

3. The system of claim 1, wherein the workstations comprise manipulator systems selected from the group consisting of robots, automatic positioning devices, manual processing devices and combinations thereof.

4. The system of claim 1, comprising at least one buffer facility.

5. The system of claim 4, wherein the transport of the sections between the workstations and between the workstations and the at least one buffer facility uses at least one transport vehicle.

6. The system of claim 1, wherein at least one of the plurality of workstations comprises an assembly and tacking apparatus for assembly and tacking together the individual components of the sections, such that the sections are capable of being transported.

7. The system of claim 1, wherein at least of the plurality of workstations comprises a connecting apparatus for joining the individual components comprising one of the sections.

8. The system of claim 1, wherein at least one of the plurality of workstations comprises a finishing apparatus for finishing manufacture of the sections, such as conforming the sections to individual equipment requirements, for performing follow-up work on the sections or a combination thereof.

9. The system of claim 1, further comprising at least one arrival repository for accommodating the individual components, and at least one departure repository for accommodating finished sections.

10. The system of claim 1, comprising two of the plurality of workstations each having assembly and tacking apparatuses, one of the plurality of workstations having a connecting apparatus and three of the plurality of workstations finishing apparatuses.

11. The system of claim 1, further comprising a control unit, a regulating unit, or both thereof.

12. A method for manufacturing sections the method comprising:
processing individual components in a plurality of workstations to form the sections
wherein in each of the plurality of workstations performs one of at least three manufacturing steps and each workstation is capable of processing sections having different shapes, different sizes or a combination thereof.

13. The method of claim 12, wherein the steps of processing includes assembling and tacking together components into a transportable state in workstation; joining the components together rigidly and permanently into sections in at least one second workstation separated by a distance from the at least one first workstation and finishing sections, performing follow-up work or a combination thereof in at least one third workstation such that the sections are adapted to individual equipment requirements.

14. The method of claim 12, wherein the step of processing ensures that residence times of the sections in the workstations are varied depending on the amount of work to be performed, wherein the amount of work to be performed is correlated to the length of sections, the cross-sectional dimensions of sections or a combination thereof.

15. The method of claim 12, wherein the steps of processing moves the sections between the workstations via at least one buffer facility.

16. The method of claim 12, wherein the steps of processing moves the sections are moved between the workstations bypassing at least one buffer facility.

17. The method of claim 12, wherein the sections are transported between the workstations, between the workstations and at least one buffer facility or a combination thereof using at least one transport vehicle that is controlled automatically, manually or a combination thereof.

18. The method of claim 13, wherein, the step of assembling and tacking selects the least degree of tacking possible using positioning devices, in order to minimize the residence time of the sections in the at least one first workstation.

19. The method of claim 12, wherein the step of processing includes joining individual components to one another using automated manipulator systems.

20. The method of claim 12, wherein the step of processing includes finishing sections in a process, the process being manual, automated or a combination thereof.

21. The method of claim 12, wherein the step of processing includes accommodating individual components in at least one arrival repository and moving finished sections to at least one departure repository.

22. The method of claim 12, wherein the step of processing includes providing two assembly and tacking apparatuses, one connecting apparatus and three finishing apparatuses.

23. The method of claim 12, wherein the step of processing includes controlling all process sequences using a control unit, a regulating unit, or a combination thereof.
